(19) United States
(12) Patent Application Publication
(10) Pub. No.: US 2025/0156967 A1
(43) Pub. Date: May 15, 2025

(54) SYSTEMS AND METHODS FOR USE IN APPLYING TREATMENTS TO CROPS IN FIELDS

(71) Applicant: CLIMATE LLC, Saint Louis, MO (US)

(72) Inventors: Nathan BESTOR, Saint Charles, MO (US); Adrian CLARKE, Oakland, CA (US); Ryan COMPTON, San Francisco, CA (US); Laura HESS, Albany, CA (US); Chris HWANG, Chattanooga, TN (US); Shilpa SOOD, Apex, NC (US); Joshua TOLLEFSON, San Francisco, CA (US); Skylar TRIGUEIRO, Half Moon Bay, CA (US); Maria WOJAKOWSKI, Milpitas, CA (US)

(21) Appl. No.: 18/940,224

(22) Filed: Nov. 7, 2024

Related U.S. Application Data
(60) Provisional application No. 63/548,142, filed on Nov. 10, 2023.

(51) Int. Cl. G06Q 50/02; G06Q 10/0635

(52) U.S. Cl. CPC G06Q 50/02; G06Q 10/0635

(57) ABSTRACT

Systems and methods are provided for use in applying treatments to crops in fields. One example computer-implemented method includes determining a growth stage vector indicative of a growth stage of a crop in a field, using a GRU-based phenology model, based on a planting date of the crop and weather data for the field. The method also includes determining a disease risk for the crop in the field based on a disease risk model and the growth stage vector, determining a residual protection of the field for a prior treatment of the field, and determining whether application of the treatment is recommended for the field based on the disease risk and the determined residual protection. The method then includes, in response to determining that application of the treatment is recommended, identifying application intervals for the treatment based on the weather data for the application intervals.

### CROSS-REFERENCE TO RELATED APPLICATION

This application claims the benefit of, and priority to, U.S. Provisional Application No. 63/548,142, filed on Nov. 10, 2023. The entire disclosure of the above-referenced application is incorporated herein by reference.

### FIELD

The present disclosure generally relates to systems and methods for use in applying one or more treatments to crops in fields.

### BACKGROUND

This section provides background information related to the present disclosure which is not necessarily prior art.

It is known for seeds to be grown in fields for commercial purposes, whereby the resulting plants, or parts thereof, are sold by the growers for business purposes and/or profit. In connection therewith, the seeds are planted in the fields, and then crops from the seeds are harvested from the fields at a later time. In the interim, the fields (and seeds/crops) are subject to various conditions. The conditions may be nature-based conditions (e.g., rainfall, temperature, etc.), or conditions imposed by the growers associated with the fields (e.g., pesticides, fertilizer, irrigation, etc.). The introduction of the conditions, by growers, for example, is known to impact the growth of the seeds in the fields, and as a result, the overall yield of the crops from the fields, which in turn impacts an amount of crops available for sale for business purposes and/or profit.

### SUMMARY

This section provides a general summary of the disclosure, and is not a comprehensive disclosure of its full scope or all of its features.

Example embodiments of the present disclosure generally relate to methods (e.g., computer-implemented methods, etc.) for use in applying treatments to crops in one or more fields. In one such embodiment, a method generally includes receiving, at a computing device, a request to recommend an application of a treatment for a field, the field including a crop, which is associated with a planting day indicative of the day the crop was planted, the request including a field identifier (ID) for the field; accessing a data structure based on the field ID, the data structure including a planting date of the crop in the field and weather data for the field, the weather data defining time series weather data for an interval; determining, by the computing device, a growth stage vector indicative of a growth stage of the crop during each increment of the interval, using a gated recurrent unit (GRU)-based phenology model, based on the planting date and weather data included in the data structure; determining, by the computing device, at least one disease risk for the crop in the field, based on at least one disease risk model and the growth stage vector, the at least one disease risk indicative of an occurrence and/or a severity of at least one disease; determining a residual protection of the field for at least one prior treatment of the field; determining whether application of the treatment is recommended for the field based on the at least on disease risk and the determined residual protection; in response to determining that application of the treatment is recommended, identifying multiple application intervals for the treatment based on the weather data for the multiple application intervals; and reporting a recommendation to apply the treatment to the field and the application intervals, in response to the request to recommend the application of the treatment.

Example embodiments of the present disclosure also generally relate to systems for use in identifying treatments for crops in one or more fields. In one such embodiment, a system generally includes at least one computing device configured to: receive a request to recommend an application of a treatment for a field, the field including a crop, which is associated with a planting day indicative of the day the crop was planted, the request including a field identifier (ID) for the field; access a data structure based on the field ID, the data structure including a planting date of the crop in the field and weather data for the field, the weather data defining time series weather data for an interval; determine a growth stage vector indicative of a growth stage of the crop during each increment of the interval, using a gated recurrent unit (GRU)-based phenology model, based on the planting date and weather data included in the data structure; determine at least one disease risk for the crop in the field, based on at least one disease risk model and the growth stage vector, the at least one disease risk indicative of an occurrence and/or a severity of at least one disease; determine a residual protection of the field for at least one prior treatment of the field; determine whether application of the treatment is recommended for the field based on the at least on disease risk and the determined residual protection; in response to determining that application of the treatment is recommended, identify multiple application intervals for the treatment based on the weather data for the multiple application intervals; and report a recommendation to apply the treatment to the field and the application intervals, in response to the request to recommend the application of the treatment.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example system of the present disclosure, which includes an agricultural computer system configured to perform one or more of the functions described herein in connection with one or more fields;

FIG. 2 illustrates example growth stages for a winter wheat crop;

FIG. 3 illustrates an example method, which may be implemented in connection with the system of FIG. 1, for use in making treatment recommendation for fields;

FIGS. 4A-4B are block diagrams that illustrate example computer systems upon which one or more embodiments of the present disclosure may be implemented; and

FIG. 5 illustrates an example implementation architecture that may be included and/or implemented in the agricultural computer system of FIG. 1, for use in performing one or more of the functions described herein.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In agriculture, treatments of crops are a significant factor in yield of the crop. Appropriate treatment is based on certain factors, which, in general, typically involve human intuition and/or estimates. The reliance on human intuition and/or estimates, rather than specific measured features of the crops, allows imprecision and/or errors into the timing of the treatments, often resulting is diminished yields from the crops. For example, for winter wheat, the growth of the crop defines, generally, three treatment or spray windows, during which one or more fungicides may be applied. At each treatment window, then, the grower makes a decision to treat or not treat, and then in the next treatment window, the grower decides again, whereby after three treatment windows, the grower has decided among six different permutations of treating or not, often with little or no feedback until an end of season harvest as to whether the treatment was successful or not. Each decision to treat, then, is a balance between unrealized benefit and the cost of the treatment. The data potentially underlying the decisions to treat, or not, is expansive. That is, the number of factors, such as, for example, phenology of the crops, predicted disease progression, and/or conditions of the field and/or surrounding environment (e.g., rainfall, temperature, humidity, soil, etc.), etc., define a problem and set of parameters impossible to be computed and/or processed in the human mind.

Uniquely, the systems and methods herein provide for recommending, and as applicable, applying, treatments to fields based on numerous parameters of the fields (e.g., weather data, phenology, etc.), as they relate to disease risk and realization of benefits of the treatments.

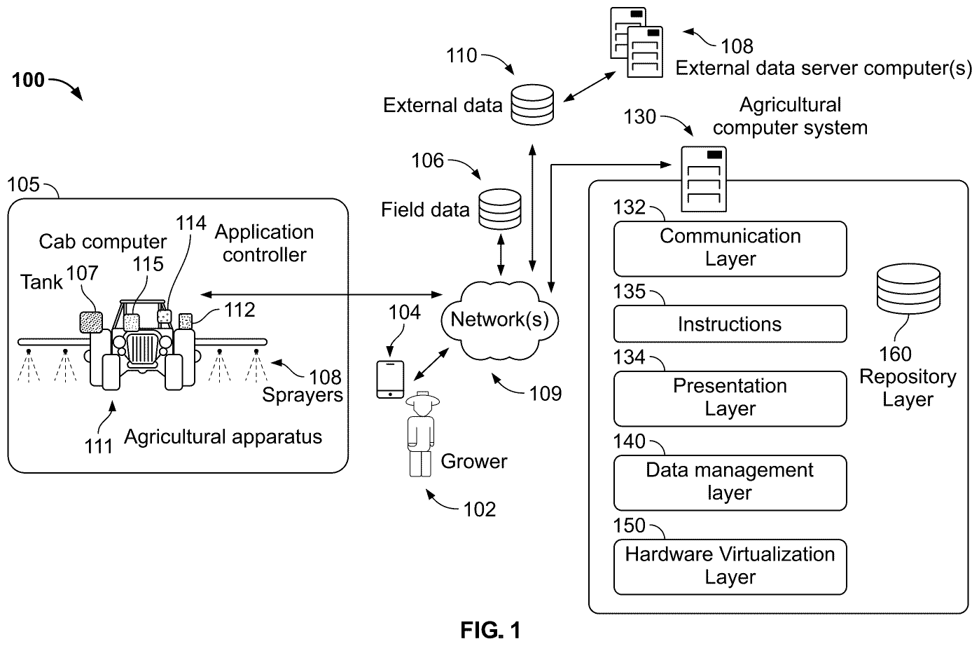

FIG. 1 illustrates an example system 100 configured to perform the functions described herein, shown in a field environment with other apparatus with which the system 100 may interoperate. In one embodiment, a user 102 may be understood to be a grower, who owns, operates or possesses a field manager computing device 104 disposed at, from time to time, a location associated with one or more fields, which are represented by the example field 105, shown in FIG. 1. The fields, in turn, are intended for use in connection with agricultural activities.

The field manager computing device 104 is programmed or configured to provide field data 106, which is associated with the one or more fields (e.g., field 105, etc.), to an agricultural computer system 130, via one or more networks 109.

Examples of field data 106 may include, without limitation: a) identification data (e.g., acreage, field name, field identifiers, geographic identifiers, boundary identifiers, crop identifiers, and any other suitable data that may be used to identify fields, such as, for example, plot numbers, geographic coordinates and boundaries, Farm Serial Number (FSN), farm number, tract number, field number, ort other suitable data; b) harvest data (e.g., crop type, crop variety, crop rotation, whether the crop is grown organically, harvest date, yield, crop price, crop revenue, grain moisture, tillage practice, and previous growing season information, etc.); c) soil data (e.g., type, composition, pH, organic matter (OM), cation exchange capacity (CEC), etc.); d) planting data (e.g., planting date, seed(s) type, relative maturity (RM) of planted seed(s), seed population, etc.); c) treatment data (e.g., fertilizer data (e.g., nutrient type (Nitrogen, Phosphorous, Potassium), application type, application date, amount, source, method) and/or chemical application (e.g., pesticide, herbicide, fungicide, other substance or mixture of substances intended for use as a plant regulator, defoliant, or desiccant, application date, amount, source, treatment details, etc.); f) irrigation data; g) weather data (e.g., precipitation, rainfall rate, predicted rainfall, water runoff rate region, temperature, wind, forecast, pressure, visibility, clouds, heat index, dew point, humidity, snow cover/depth, air quality, sunrise, sunset, sunlight, etc.); and h) imagery data (e.g., imagery and light spectrum information from an agricultural apparatus sensor, camera, computer, smartphone, tablet, unmanned aerial vehicle, planes or satellite); etc.

In addition, the system 100 includes an external data server computer 108 (or data server), which is communicatively coupled to agricultural computer system 130 and is programmed or configured to send external data 110 to agricultural computer system 130, through one or more networks, represented by the network(s) 109.

The external data server computer 108 may be owned or operated by the same legal person or entity as the agricultural computer system 130, or by a different person or entity such as a government agency, non-governmental organization (NGO), and/or a private data service provider, etc. Examples of external data may include weather data, imagery data, soil data, or statistical data relating to crop yields, among others. External data 110 may consist of the same type of information as field data 106. In some embodiments, the external data 110 is provided by the external data server computer 108, where the computer 108 is owned by the same entity that owns and/or operates the agricultural computer system 130. For example, the agricultural computer system 130 may include a data server focused exclusively on a type of data that might otherwise be obtained from third party sources, such as weather data. In some embodiments, the external data server computer 108 may actually be incorporated within the system 130.

It should be understood that the field 105 may include, without limitation, any suitable growing space(s) for a crop (e.g., hundreds of acres or more or less, tens of acres, several acres, an acre, a plot, a greenhouse, etc.). The field 105 is defined by boundaries. In connection with a growing operation, the field 105 is planted with specific seeds (e.g., by an agricultural apparatus, etc.), as determined or selected by the user 102, or another user associated with the field 105. The seeds then grow into a crop on the field 105. The crop, in this example embodiment, includes wheat, and specifically, winter wheat. That said, other crops, such as, for example, maize, soybeans, barley, oat, cotton, canola, oilseed rape (OSR), etc., may be included in the field 105 in other embodiments.

As shown in FIG. 1, an agricultural apparatus 111 is disposed in the field 105, and is configured, generally, to perform one or more operations at the field 105 (e.g., seed planting, application of treatment, harvesting, etc.). In this specific embodiment, the agricultural apparatus 111 is a sprayer apparatus, which is configured to apply one or more treatments to the field 105. In particular, for example, the sprayer apparatus includes one or more holding tanks 107 for a treatment and one or more sprayer nozzles 108, which are positioned on a boom extending from each side of a cab to apply (e.g., spray, etc.) the treatment in a manner prescribed for the specific treatment, etc. It should be appreciated that the agricultural apparatus 111 may be of a different type and/or configured otherwise in other embodiments. In addition, other, different agricultural apparatus may be included in the system 100, for example, in the field 105 or other fields, in other embodiments. Generally, examples of agricultural apparatus as used herein may include, without limitation, tractors, combines, harvesters, planters, trucks, fertilizer equipment, sprayers, aerial vehicles including manned or unmanned aerial vehicles, and any other item of physical machinery or hardware, typically mobile machinery, and which may be used in tasks associated with agriculture.

In this example embodiment, as shown, the agricultural apparatus 111 in the system 100 may have one or more remote sensors 112 fixed thereon or coupled thereto, which sensors are communicatively coupled either directly or indirectly via agricultural apparatus 111 to the agricultural computer system 130 and which are programmed or configured to send sensor data to agricultural computer system 130. In some embodiments, agricultural apparatus 111 may comprise a plurality of sensors 112 that are coupled locally in a network on the agricultural apparatus 111, where a controller area network (CAN) is an example of such a network that can be installed in combines, harvesters, sprayers, and cultivators. Application controller 114 is communicatively coupled to agricultural computer system 130, through the network(s) 109, and is programmed or configured to receive one or more scripts, from the agricultural computer system 130, that are used to control an operating parameter of the agricultural apparatus 111 and/or implementation thereof. For instance, a CAN bus interface may be used to enable communications from the agricultural computer system 130 to the agricultural apparatus 111, for example, via the CLIMATE FIELDVIEW DRIVE, available from The Climate Corporation, St. Louis, Missouri, etc. Sensor data may include the same type of information as field data 106.

While the sensors 112 are illustrated as fixed to the agricultural apparatus 111 in FIG. 1, the sensors 112 may be remote therefrom, yet disposed in and/or around the field 105 and may communicate with the agricultural apparatus 111 or the network 109 directly.

The agricultural apparatus 111 may further comprise a cab computer 115 that is programmed with a cab application, which may comprise a version or variant of a mobile application included at device 104 (or otherwise) that is further described in other sections herein. In an embodiment, cab computer 115 may include a compact computer, for example, a tablet-sized computer or smartphone, with a graphical screen display, such as a color display, that is mounted within the cab of the apparatus 111. Cab computer 115 may implement some or all of the operations and functions that are described further herein for the computing device 104.

The network(s) 109 broadly represent any combination of one or more data communication networks including local area networks, wide area networks, internetworks or internets, using any of wireline or wireless links, including terrestrial or satellite links. The network(s) 109 may be implemented by any medium or mechanism that provides for the exchange of data between the various elements of FIG. 1. The various elements of FIG. 1 may also have direct (wired or wireless) communications links. The sensors 112, controller 114, external data server computer 108, and other elements of the system may each comprise an interface compatible with the network(s) 109 and may be programmed or configured to use standardized protocols for communication across the networks (e.g., wide area network (WAN, local area network (LAN), mobile network, etc.)), such as, for example, TCP/IP, Bluetooth, CAN protocol and higher-layer protocols, such as, for example, HTTP, TLS, and the like.

In this example embodiment, the agricultural computer system 130 is programmed or configured to receive field data 106 from field manager computing device 104, external data 110 from external data server computer 108, and/or sensor data from remote sensor 112 (and/or other sensors). The agricultural computer system 130 may be further configured to host, use or execute one or more computer programs, other software elements, digitally programmed logic such as FPGAs or ASICs, or any combination thereof to perform translation and storage of data values, construction of digital models of one or more crops on one or more fields, generation of recommendations and notifications, and generation and sending of scripts to application controller 114, in the manner described further in other sections of this disclosure.

In an embodiment, the agricultural computer system 130 is programmed with or comprises a communication layer 132, a presentation layer 134, executable instructions 135 to cause performance of one or more operations described herein, a data management layer 140, a hardware virtualization layer 150, and a repository layer 160. “Layer,” in this context, refers to any combination of electronic digital interface circuits, microcontrollers, firmware such as drivers, and/or computer programs or other software elements.

In particular, the communication layer 132 may be programmed or configured to perform input/output interfacing functions including sending requests to field manager computing device 104, external data server computer 108, application controller 114, cab computer 115, and remote sensor 112 for field data, external data, and sensor data respectively. The communication layer 132 may be programmed or configured to send the received data to repository layer 160 to be stored as field data 106. And, the presentation layer 134 may be programmed or configured to generate a graphical user interface (GUI) to be displayed on field manager computing device 104, cab computer 115 or other computers that are coupled to the system 130 through the network 109. The GUI may comprise controls for inputting data to be sent to agricultural computer system 130, generating requests for models and/or recommendations, and/or displaying recommendations, notifications, models, and other field data.

The data management layer 140 may be programmed or configured to manage read operations and write operations involving the repository layer 160 and other functional elements of the system, including queries and result sets communicated between the functional elements of the system and the repository. Examples of data management layer 140 include JDBC, SQL server interface code, and/or HADOOP interface code, among others. The repository layer 160 may comprise a database. As used herein, the term “database” may refer to cither a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. However, any database may be used that enables the systems and methods described herein.

When field data 106 is not provided automatically to the agricultural computer system 130 via one or more agricultural machines or agricultural machine devices that interacts with the agricultural computer system 130, the user (or grower) 102 may be prompted via one or more user interfaces on the device 104 (served by the agricultural computer system 130) to input such information. The data is input to the data management layer 140, as programmed or configured above.

In an embodiment, model and field data is stored in the repository layer 160. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer.

In an embodiment, instructions 135 comprise a set of one or more pages of main memory, such as RAM, in the agricultural computer system 130 into which executable instructions have been loaded and which when executed cause the agricultural computer system 130 to perform the functions or operations that are described herein. For example, the instructions 135 may comprise a set of pages in RAM that contain instructions which when executed cause determining phenology, residual treatment, and/or compiling treatment recommendations, based thereon, that are described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, the instructions 135 also may represent one or more files or projects of source code that are digitally stored in a mass storage device such as non-volatile RAM or disk storage, in the agricultural computer system 130 or a separate repository system, which when compiled or interpreted cause generating executable instructions which when executed cause the agricultural computer system 130 to perform the functions or operations that are described herein.

Instructions 135 comprise computer readable instructions which, when executed by one or more processors, cause agricultural computer system 130 to, for example: receive a request to recommend an application of a treatment for a crop in a field, where the crop is associated with a planting day indicative of the day the crop was planted and where the request includes a field ID for the field; access a data structure including planting data and weather data; calculate a growth stage of the crop in the field on a defined day, via a phenology model, based on the planting data and weather data included in the data structure; determine whether the calculated growth stage is within a spray window for the crop; calculate at least one disease risk for the crop in the field, based on at least one disease risk model, where the at least one disease risk is indicative of an occurrence and/or a severity of at least one disease; compile a recommendation for a treatment at a specific time and/or date, based on the same; and then, directing treatment to the crop consistent with the recommendation associated with the selected one of the responses; and/or transmit the report in response to the request.

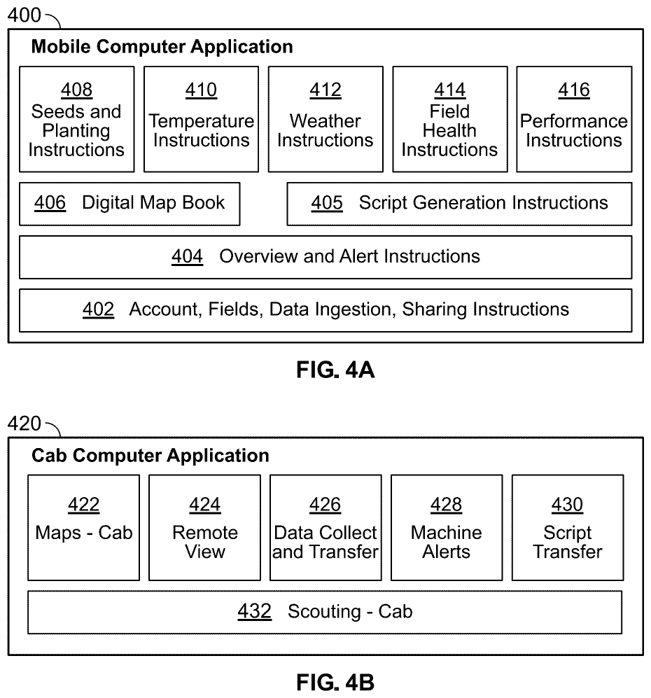

Hardware virtualization layer 150 comprises one or more central processing units (CPUs), memory controllers, and other devices, components, or elements of a computer system such as volatile or non-volatile memory, non-volatile storage such as disk, and I/O devices or interfaces as illustrated and described, for example, in connection with FIG. 4. The layer 150 also may comprise programmed instructions that are configured to support virtualization, containerization, or other technologies.

For purposes of illustration, FIG. 1 shows a limited number of instances of certain functional elements. However, in other embodiments, there may be any number of such elements. For example, embodiments may use thousands or millions of different manager computing devices 104 associated with different users. Further, the agricultural computer system 130 and/or external data server computer 108 may be implemented using two or more processors, cores, clusters, or instances of physical machines or virtual machines, configured in a discrete locations or co-located with other elements in a datacenter, shared computing facility or cloud computing facility.

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, the present disclosure is intended to provide disclosure of algorithms, plans or directions that are sufficient to permit a skilled person to program a computer to perform the functions that are described herein, in combination with the skill and knowledge of such a person given the level of skill that is appropriate for disclosures of this type.

In an embodiment, user 102 interacts with agricultural computer system 130 using field manager computing device 104 configured with an operating system and one or more application programs or apps. The field manager computing device 104 also may interoperate with the agricultural computer system 130 independently and automatically under program control or logical control, such that direct user interactions is not always required. As described, field manager computing device 104, broadly, represents one or more of a smart phone, PDA, tablet computing device, laptop computer, desktop computer, workstation, or any other computing device capable of transmitting and receiving information and performing the functions described herein. Field manager computing device 104 may communicate via the network 109 using a mobile application stored on field manager computing device 104, and in some embodiments, the device 104 may be coupled using a cable or connector to the sensor 112 and/or controller 114.

The mobile application may provide client-side functionality, via the network 109 to one or more computing devices (e.g., a mobile computing device, a manager computing device, etc.). In an example embodiment, field manager computing device 104 may access the mobile application via a web browser or a local client application or app. Field manager computing device 104 may transmit data to, and receive data from, one or more front-end servers, using web-based protocols or formats such as HTTP, XML and/or JSON, or app-specific protocols. In an example embodiment, the data may take the form of requests and user information input, such as field data, into the computing device. In some embodiments, the mobile application interacts with location tracking hardware and software on field manager computing device 104 which determines the location of field manager computing device 104 using standard tracking techniques such as multilateration of radio signals, the global positioning system (GPS), WiFi positioning systems, or other methods of mobile positioning. In some cases, location data or other data associated with the device 104, user 102, and/or user account(s) may be obtained by queries to an operating system of the device or by requesting an app on the device to obtain data from the operating system.

In an embodiment, field manager computing device 104 sends field data 106 to agricultural computer system 130. Field manager computing device 104 may send field data 106 in response to user input from user 102 specifying the data values for the one or more fields (e.g., field 105, etc.). Additionally, field manager computing device 104 may automatically send field data 106 when one or more of the data values becomes available to field manager computing device 104.

A commercial example of the mobile application is CLIMATE FIELDVIEW, commercially available from The Climate Corporation, St. Louis, Missouri. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it may, for example, combine historical data about the grower's fields with any other data that the grower desires to compare. The combinations and comparisons may be performed in real time, or not, and are based upon scientific models that provide potential scenarios to permit the grower to make better, more informed decisions.

In an embodiment, external data server computer 108 stores external data 110, including soil data representing soil composition for the one or more fields (e.g., field 105, etc.) and weather data representing temperature and precipitation on the one or more fields. The weather data may include past and present weather data as well as forecasts for future weather data. In an embodiment, external data server computer 108 comprises a plurality of servers hosted by different entities. For example, a first server may contain soil composition data while a second server may include weather data.

In an embodiment, remote sensor 112 comprises one or more sensors that are programmed or configured to produce one or more observations. While illustrated on the agricultural apparatus 111 in FIG. 1, it should be appreciated that the remote sensor 112 may be apart from the agricultural application 111 in other embodiments. That said, the remote sensor 112 may include one or more aerial sensors, such as satellites, vehicle sensors, planting equipment sensors, tillage sensors, fertilizer or insecticide application sensors, harvester sensors, and any other implement capable of receiving data from the one or more fields. In an embodiment, application controller 114 is programmed or configured to receive instructions from agricultural computer system 130. Application controller 114 may also be programmed or configured to control an operating parameter of agricultural apparatus 111 based on one or more instructions generated with respect to the features described herein. In other embodiments, an application controller may be programmed or configured to control an operating parameter of another agricultural apparatus or vehicle, such as a tractor, planting equipment, tillage equipment, fertilizer or insecticide equipment, harvester equipment, or other farm implements such as a water valve. Other embodiments may use any combination of sensors and controllers, of which the following are merely selected examples.

In an embodiment, examples of sensors that may be used in relation to apparatus for applying fertilizer, insecticide, fungicide and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors such as accelerometers disposed on sprayer booms. In an embodiment, examples of controllers 114 that may be used with such apparatus include pump speed controllers; valve controllers that are programmed to control pressure, flow, direction, pulse width modulation (PWM) and the like; or position actuators, such as for boom height, subsoiler depth, or boom position.

In an embodiment, examples of sensors 112 that may be used with any moving vehicle or apparatus of the type described elsewhere herein include kinematic sensors and position sensors. Kinematic sensors may comprise any of speed sensors such as radar or wheel speed sensors, accelerometers, or gyros. Position sensors may comprise GPS receivers or transceivers, or WiFi-based position or mapping apps that are programmed to determine location based upon nearby WiFi hotspots, among others.

In an embodiment, examples of sensors 112 that may be used with tractors or other moving vehicles include engine speed sensors, fuel consumption sensors, area counters or distance counters that interact with GPS or radar signals, PTO (power take-off) speed sensors, tractor hydraulics sensors configured to detect hydraulics parameters such as pressure or flow, and/or and hydraulic pump speed, wheel speed sensors or wheel slippage sensors. In an embodiment, examples of controllers that may be used with tractors include hydraulic directional controllers, pressure controllers, and/or flow controllers; hydraulic pump speed controllers; speed controllers or governors; hitch position controllers; or wheel position controllers provide automatic steering.

The agricultural computer system 130 may obtain or ingest data under user control, on a mass basis from a large number of growers who have contributed data to a shared database system. This form of obtaining data may be termed “manual data ingest” as one or more user-controlled computer operations are requested or triggered to obtain data for use by the agricultural computer system 130. As an example, the CLIMATE FIELDVIEW application, commercially available from Climate LLC, St. Louis, Missouri, may be operated to export data to agricultural computer system 130 for storing in the repository layer 160.

With continued reference to FIG. 1, the agricultural computer system 130 is programmed and/or configured to generate a treatment recommendation for one or more fields (e.g., field 105, etc.).

In particular, in this example embodiment, the agricultural computer system 130 is programmed and/or configured to determine disease risk for one or more diseases associated with the field 105, for example, to determine a residual effect of one or more prior treatments (if any), and to determine and notify the user 102 of a specific time interval for the treatment, if recommended. Optionally, the agricultural computer system 130 is also programmed and/or configured to determine a return on investment (ROI) for the treatment based on yield response as part of making a recommendation to the grower.

Initially, a request for a treatment recommendation is received at the agricultural computer system 130. The request may be received, from the field manager computing device 104, as an email, application programming interface (API) call, or otherwise. In one example, the user 102 selects an option for a treatment recommendation in an application of the field manager computing device 104 (e.g., the CLIMATE FIELDVIEW application, etc.). The request, regardless of manner of receipt, generally includes an indication of the field 105, in this example, based on a field identifier, location, etc. The request may further include one or more diseases of particular interest to the user 102, an identification of a treatment (e.g., treatment type, treatment name, treatment timing, etc.), or other information relevant to a treatment in the field 105, etc.

In response to the request, the agricultural computer system 130 is programmed and/or configured to access data related to the field 105. The data may include field data 106 and external data 110. The field data 106, in this example, may include, without limitation, the planting date for the crop in the field 105; prior treatments (e.g., treatment type, treatment date, etc.); location data for the field 105 (e.g., latitude, longitude, country, etc.); sensor data captured from the field 105 related to soil, weather, etc. (e.g., from the sensor 112 or other sensor, etc.); and other suitable data; etc. The field data 106 also includes a last observation and/or previous observation(s) (e.g., manual, automated, etc.) of growth stages for the crop presently in the field 105 and dates of the observations.

The external data 110 may include, in this example, without limitation, historical weather data for the field 105, or a region that includes the field 105. In particular in this example, the historical weather data includes series data for the field 105. In connection therewith, the weather data may include temperature data such as, for example, daily mean temperatures (e.g., in degrees Celsius or Fahrenheit, etc.) for the field 105, and also daily maximum temperatures for the field 105 (e.g., in degrees Celsius or Fahrenheit, etc.). The weather data may also include daily average relative humidity percentages, soil moisture, precipitation (e.g., in millimeters, inches, etc.), snow depth (e.g., in meters, feet, etc.), daylight, etc. In addition to the historical weather data, the agricultural computer system 130 is programmed and/or configured to further access forecast weather data for the field 105, or a region that includes the field 105, for the next weeks, months, or remainder of the year, etc. Similar to the historical weather data, the forecasted weather data includes a time series forecast of daily mean temperatures, maximum temperatures, mean humidity, etc. While the weather data is daily, in this example, it should be appreciated that other intervals of weather data may be used in other examples.

The historical and forecast weather data, as appropriate, is combined into a vector for each of the inputs. As such, for example, for maximum temperature, the data is a vector of X values of temperature from a planting day to X days beyond the planting day (e.g., end of a season, end of month, end of calendar year, etc.). As such, maximum temperature data includes a vector, for example, of one hundred eighty temperatures, one for each day in the interval. The agricultural computer system 130 is programmed and/or configured to access and/or compile the data into the same form of data vectors, for example, for mean temperature, mean humidity, and other time series data, etc.

Further, the agricultural computer system 130 is programmed and/or configured to access other data associated with the crop in the field 105 and the treatment that may be recommended for the field 105. The other data may include treatment cost data, for example, which may indicate a cost to treat the field 105, and also revenue data, which may include pricing for weather (in this example) and predicted yield values with and without the treatment. The yield values may be predicted based on one or more yield models. Further, the other data may include calendar data, such as, for example, day length and days of the year, etc.

It should be appreciated that data in addition to the specifically identified data above may be accessed, as related to the field 105 and/or treatment of the field 105. The data may be additional field data, or weather data, or a further type of data determined to be associated with and/or relevant to the treatment of the field 105.

The accessed data is referenced herein as input data for determining a recommendation to treat or not treat the crop in the field 105.

In addition to the above described data, the agricultural computer system 130 is programmed and/or configured to access a phenology model, which in turn is structured to define one or more growth stages for a crop, given certain input data. With reference to the phenology model, the input layers are designated by the provided input features, and the input layers feed into a sequential layer comprising Gated Recurrent Units (GRU). The sequential layer then feed into a time distributed layer including a neural network, which utilizes, in this example, shared weights. And, the time distributed layer feeds into a combination of a thresholding and sigmoid function layer to produce a vector output for possible predicted phenology stages. The model is optimized/trained/learns through using one or more approaches of backward propagation of losses through gradient descent, for example.

In more detail, in this example embodiment, the phenology model includes a various gated recurrent units (GRUs) model. The GRUs form a times-series model, which includes multiple layers to learn the association function, that given the historical features (e.g., weather features, etc.), indicate a probability forecast vector of growth stages of the defined interval, etc. As such, the GRUs relies on time series input data, or data vectors, as explained above, whereby the model is then configured to accept a number of inputs as indicative of the growth stages (e.g., as compared to other models, which may simply rely on thermal time, etc.). Specifically, for purposes of illustration, the model includes at least two layers of GRUs (e.g., between two and eight layers, etc.), and more preferably, six layers, which may include, in total, between twenty and one hundred GRUs, or more preferably, between fifty and seventy-five GRUs. The input features for the GRU are of the following time series data: daily recorded weather features such as mean temperature, snow depth, soil moisture, humidity, and precipitation; day length (in terms of sunlight); location information in latitude/longitude and/or country; and prior observed phenology stages; etc. In this example embodiment, the model includes a neural network, where the GRUs are implemented in conjunction with the neural network, which is a time distributed, feedforward neural network.

In this exemplary embodiment, the neural network is further implemented in connection with a thresholding layer, which is associated with an output vector, whereby the thresholding layer includes a cost function, such as, for example, a binary cross entropy function, which may be customized based on the specific implementation, or not. One example customization includes masking days in which no phenology observations are available (to remove the same from updating the internal weights within the layer), etc.

Notwithstanding the above, the particular implementation of the GRUs in one or more layers in conjunction with a neural network, or other network, may be different in other system embodiments, whereby the number of GRUs, the number of layers of GRUs, etc., may be different depending on the particular implementation.

It should be appreciated that the model is trained based on one or more training data sets and/or validated based on one or more validation data sets, which include the input data described above (e.g., time series data vectors, etc.) and verified growth stages for the crops in the fields represented by the data sets. The training may be performed iteratively, to adjust the hyperparameters, etc., to secure a desired performance from the model.

It should further be appreciated that growth stages for the crop are generally expressed as numeric values indicative of particular stages. Table 1 illustrates an example listing of growth stages for winter wheat. It should also be appreciated that while Table 1 is expressed in terms of the BBCH scale, a different index/scale may be employed in other embodiments of the phenology model to identify a growth stage based on the above inputs.

TABLE 1

| Phenology | |
|---|---|
| stage (BBCH) | Phenology stage (description) |
| BBCH 5 | germination |
| BBCH 10 | emergence |
| BBCH 29 | End of tillering. (Earliest start of T1 spray window, |
| | depending on country) |
| BBCH 30 | terminal spikelet |
| BBCH 31 | first node |
| BBCH 32 | second node |
| BBCH 33 | third node (Latest end of T1 spray window, |
| | depending on country) |
| BBCH 37 | flag leaf visible (earliest start of T2 spray window, |
| | depending on country) |
| BBCH 39 | flag leaf fully emerged (latest end of T2 spray |
| | window, depending on country) |
| BBCH 45 | late boot stage |
| BBCH 51 | start of heading |
| BBCH 55 | middle of heading |
| BBCH 59 | end of heading |
| BBCH 61 | start of flowering (earliest start of T3 spray |
| | window, depending on country) |
| BBCH 65 | 50% flowering completed (latest end of T3 spray |
| | window, depending on country) |
| BBCH 69 | end of flowering |
| BBCH 71 | watery ripe |
| BBCH 75 | medium milk |
| BBCH 85 | soft dough |
| BBCH 89 | physiological maturity |
| BBCH 99 | harvest |

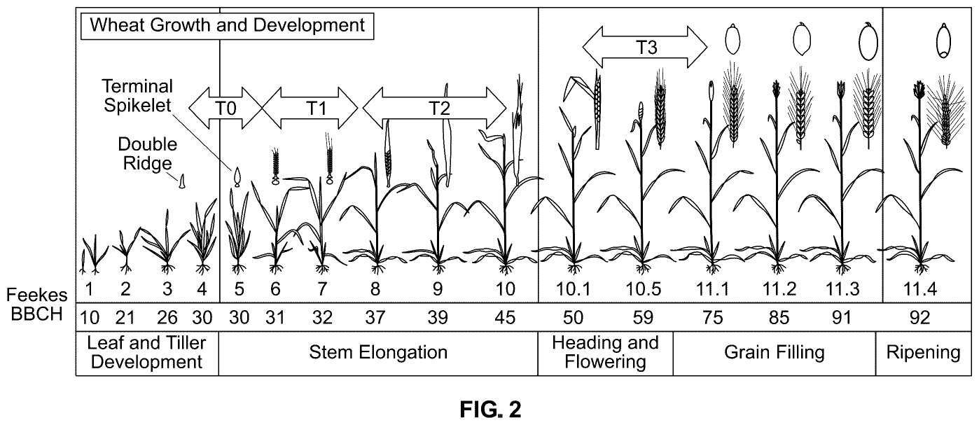

As additionally shown in FIG. 2, for example, a crop (in this example, winter wheat) is grown in a field, over a time between a planting of the seed and a ripening or harvest of the crop. In particular, FIG. 2 illustrates a growth stage diagram, which includes the growth stages of the winter wheat, as indicated by a desired index (e.g., the BBCH scale in this example, etc.), from planting of the seeds forward until ripening and harvest. As shown, in accordance with the index, the winter wheat progresses from leaf and tiller development, stem elongation, heading and flowering, grain flowering and ripening. It should be appreciated that the growth stage diagram in FIG. 2 is a specific example for winter wheat and that other growth stages may be employed in other system embodiments, in connection with phenology or otherwise.

Given the above, in connection with training the model, the training may be biased toward ones of the growth stages, which, for example, may be more indicative of disease. For example, the model may be trained to generate prediction for only certain ones of the identified growth stages, i.e., target growth stages. Example target growth stages may include, without limitation, one or more of growth stages 23, 24, 25, 26, 27, 28, 29, 30, 31, 32, 33, 37, 39, 45, 51, 55, 59, 61, 65, 69, 71, 75, 85, 89, 92, and/or 99. The training may emphasize the target growth stages, for example, by weights or hyperparameters associated with the specific target growth stages and/or accuracy in predicting the target growth stages, etc.

Once the data and model are accessed/retrieved, the agricultural computer system 130 is programmed and/or configured to generate, using the phenology mode and input data, the predicted growth stage for the crop from one date (e.g., the current date, etc.) for the remainder of the growing season, the remainder of the calendar year or some other suitable interval, etc. That is, the output from the phenology model includes a vector of days from a start date forward, for the remainder of the calendar year, for example, with a growth stage listed for each day, or a growth stage list for changes in growth stages (e.g., days at which the crop advances to the next growth stage, etc.).

It should be appreciated that the model, as described above, is configured to generate the output vector of growth stages over the interval of days, rather than discrete growth stages (i.e., one run per day for a process model, for example), whereby efficiencies in runtime prediction of growth stages are gained through the model above.

Next, the agricultural computer system 130 is programmed or configured to execute one or more specific models for one or more diseases, based on the input data and the growth stage per day, from the phenology model. It should be appreciated that the specific disease model(s), when/if multiple are used, may be executed, by the agricultural computer system 130, in parallel or sequentially, depending on, for example, available processing resources, time constraints, etc. In connection therewith, example models for septoria, leaf rust, stripe rust, and fusarium are discussed below. It should be appreciated, though, that other models for these diseases and/or models for other diseases may be used in other example embodiments.

Septoria Model. An example septoria model may configure or program the agricultural computer system 130 to determine a daily severity risk of septoria disease, for example, for winter wheat (or other crop) in the field 105, from the current date forward for a given year. The severity risk of septoria may be provided on any desired scale, for example, low, medium, high, etc.

The septoria model is based on various features associated with the crop and/or the field 105, which may be dependent on the type of modeling initially employed to build the model. Optionally, the septoria model may be built based on, at least, random forest (RF), long short-term memory (LSTM), and/or process model techniques, or a combination/ensemble of any of these methods. Each of the different modeling techniques may be subject to the same or different data features (from the input data and/or feature engineering), upon which the model is then able to predict the septoria risk. Example data features, that may be employed in each of the above modeling techniques, are listed in Table 2 below. In addition to the above, the septoria model may rely on the planting date of the field 105, the location of the field 105, for example, to derive data features of the model (e.g., location combined with weather data, etc.).

TABLE 2

| | Example | Example Data |
|---|---|---|
| Example Data Features in RF | Data Features | Features in Process |
| Model | in LSTM Model | Model |
| Accumulated temperature risk | Daily mean | Temperature (daily |
| Accumulated precipitation risk | temperature | mean) |
| Accumulated relative humidity | Daily mean | Precipitation (daily |
| risk | relative humidity | total) |
| Accumulate condensation risk | Daily sum | Relative humidity |
| Accumulate max rain rate | precipitation | (daily mean) |
| Longitude/latitude | Fungicide | Fungicide |
| Days after planting at assessment | (application date) | (application date) |
| Days after last application | Crop_stage_at_ | |
| Crop stage | appl | |
| Frac_7_days_after_planting_appl | | |
| Frac_3_days_after_planting_appl | | |
| Total_dose | | |

In this example embodiment, the septoria model may be built through use of LSTM units, and as such, is based on the data features including, without limitation, daily mean temperature, daily mean relative humidity, daily sum of precipitation on the field 105 (e.g., since planting, etc.), whether a treatment (e.g., fungicide, etc.) has been applied and the application date relative to the growth stage (and potentially, the chemistry and/or ingredients of the treatment), if applied, other phenology observations of the field 105 and/or crop in the field 105, etc.

Based on the above, the agricultural computer system 130 is configured or programmed, by the septoria model, to determine a daily severity risk of septoria infection in the crop in the field 105. It should be appreciated that, while the severity of septoria is determined through the septoria model in this embodiment, the occurrence of septoria may also, or alternatively, be determined through a different version(s) of the model, and combined, and then used to determine a predicted response as described below.

Leaf Rust Model. An example leaf rust model may configure or program the agricultural computer system 130 to determine a daily severity risk of leaf rust (or brown rust) disease, for example, for winter wheat (or other crop) in the field 105, from the current date forward for a given year. The severity risk of leaf rust may be provided on any desired scale, for example, low, medium, high, etc.

Like above, the leaf rust model is based on various features associated with the crop and/or the field 105, which may be dependent on the type of modeling initially employed to build the model. Optionally, the leaf rust model may be built based on, at least, random forest and/or LSTM techniques and/or Gaussian processes. Each of the different modeling techniques may be subject to the same or different data features (from the input data), upon which the model is then able to predict the leaf rust risk.

In this example embodiment, the leaf rust model is defined based on the random forest model, which is dependent on temperature and the relative humidity (RH). That said, it should be appreciated that other feature data may form the basis for the leaf rust model in other embodiments, including, without limitation, other weather data, fungicide applications (e.g., chemistry, date, etc.), genetic disease susceptibility, soil data, topographic data, tillage data, rotation data, irrigation data, etc. With respect to the leaf rust model, for the specific data herein, the model relies on the temperature risk where the risk has a value, for example, on an hourly or other interval basis, as represented by Equation 1 below. In some examples, the temperature risk may have a value of 1 in a specific temperature range (e.g., between about 15° C. and about 25° C., etc.), and a value of 0 otherwise. And, the relative humidity risk may have a value, for example, on an hourly or other interval basis, as represented by Equation 2. In some examples, the relative humidity risk may have a value of 1 above a lower bound threshold (e.g., about 70%, etc.), and a value of 0 otherwise, on an hourly or other interval basis, etc. The temperature risk may then be combined with the humidity risk (e.g., temp risk×RH risk, etc.) as desired (e.g., summed, averaged, etc.), etc.

$$temp\_risk = 1. / ( 1. + exp ( - 0.8 * ( t - 12.5 ) ) ) , if t < 25 \\ 1 - ( t - 25 ) \hat{} 2 / 100 , if 25 <= t <= 35 \\ 0 , if t > 35 \qquad ( 1 )$$

where t is hourly temperature

$$relative\_humidity \_risk = 1. / ( 1. + exp ( - 0.27 * ( rh - 77.5 ) ) ) \\ where rh is hourly relative humidity \qquad ( 2 )$$

It should be appreciated that the integer values 0 and 1 are not the only way to represent the risk associated with temperature and relative humidity. The severity risk may be, for example, a continuation risk function based on the temperature and/or relative humidity. Table 3, for example, defines the risk values as continuous values.

TABLE 3
Weighted Hourly Weather Risk

| | Temperature Risk (C.) | Relative Humidity (RH) Risk | Temp Risk X RH Risk |
|---|---|---|---|
| Parameters | Temp_min: 0 | Rh_min: 70% | |
| | Temp_opt_min: 15 | Rh_opt: 85% | |
| | Temp_opt_max: 25 | | |
| | Temp_max: 35 | | |
| Risk | Less than temp_min: 0 | Sigmoid function | Temp Risk X RH risk |
| formula | [Temp_min, temp_opt_max]: | | |
| | sigmoid | | |
| | [Temp_opt_max, temp_max]: | | |
| | quadratic | | |
| | Greater than temp_max = 0 | | |

Based on the data features, as expressed above (e.g., continuous, binary, etc.), the agricultural computer system 130 is programmed or configured to determine leaf rust risk associated with the specific crop in the field 105. In particular, the agricultural computer system 130 is configured or programmed to cumulate the risk for the crop, from planting until the current date, whereby the daily risk (or hourly or other interval of risk) for the crop, based on the above thresholds for the different data features, is summed to provide an overall risk of leaf rust for the crop in the field 105. Generally, the summed risk is positively correlated with predicted severity. The summed risk and other features (e.g., fungicide application information such as time and ingredient(s), etc.) are provided into a random forest algorithm that aggregates the result of many decision trees to produce a single predicted severity.

In this way, in connection with predicting disease risk (e.g., for leaf rust, etc.) on a particular date, if there was a particular fungicide application in the past within a last 10-30 days, etc., the leaf rust model may configure or program the agricultural computer system 130 to determine a relatively low risk for the disease. However, if the particular fungicide application was done in the past more than 30 days ago, the leaf rust model may configure or program the agricultural computer system 130 to interpret the fungicide effect to have run off and determine a relatively higher risk for the disease.

In this manner, the agricultural computer system 130 is configured or programmed, by the leaf rust model, to determine a daily severity risk of leaf rust infection in the crop in the field 105. That said, it should be appreciated that, while the severity of leaf rust is determined through the leaf rust model in this embodiment, the occurrence of leaf rust may also, or alternatively, be determined through a different version(s) of the model(s) and combined, and then used to determine a predicted response as described below.

Stripe Rust Model. An example stripe rust model may configure or program the agricultural computer system 130 to determine a daily severity risk of the stripe rust (or yellow rust) disease for winter wheat in the field 105 from the current date forward for a given year. The severity risk of stripe rust may be provided on any desired scale, for example, low, medium, high, etc.

In this example embodiment, the stripe rust model is defined based on the random forest model, which is dependent on temperature and relative humidity (RH). That said, it should be appreciated that other feature data may form the basis for the stripe rust model in other embodiments, including, without limitation, other weather data, fungicide applications (e.g., chemistry, date, etc.), genetic disease susceptibility, soil data, topographic data, tillage data, rotation data, irrigation data, etc. With respect to the stripe rust model, for the specific data herein, the model relies on the temperature risk where the risk has a value, for example, on an hourly or other interval basis, as represented by Equation 3. In some examples, the temperature risk may have a value of 1 in a specific temperature range (e.g., between about 15° C. and about 25° C., etc.), and a value of 0 otherwise. And, the relative humidity risk may have a value, for example, on an hourly or other interval basis, as represented by Equation 4. In some examples, the relative humidity risk may have a value of 1 above a lower bound threshold (e.g., about 70%, etc.), and a value of 0 otherwise, on an hourly or other interval basis, etc. The temperature risk may then be combined with the humidity risk (e.g., temp risk×RH risk, etc.) as desired, etc. (e.g., summed, averaged, etc.).

$$temp\_risk = 1. / ( 1. + exp ( - 1 * ( t - 7 ) ) ) , if t < 15 \\ 1 - ( t - 25 ) \hat{} 2 / 100 , if 15 <= t <= 73 \\ 0 , if t > 73 \qquad ( 3 )$$

where t is hourly temperature

$$relative\_humidity \_risk = 1. / ( 1. + exp ( - 0.27 * ( rh - 77.5 ) ) ) \qquad ( 4 )$$

where rh is hourly relative humidity

It should be appreciated that the binary values 0 and 1 are not the only way to represent the risk associated with temperature and relative humidity in the stripe rust model. The risk may be, for example, a continuation risk function based on the temperature and/or relative humidity. Like for leaf rust, Table 4, for example, defines the risk values as continuous values.

TABLE 4
Weighted hourly weather risk

| | Temperature risk | Relative humidity risk | Temp risk X RH risk |
|---|---|---|---|
| Parameters | Temp_min: 5 | Rh_min: 70% | |
| | Temp_opt_min: 9 | Rh_opt: 85% | |
| | Temp_opt_max: 15 | | |
| | Temp_max: 73 | | |
| Risk | Less than temp_min: 0 | Sigmoid function | Temp risk X RH risk |
| formula | [Temp_min, temp_opt_max]: | | |
| | sigmoid | | |
| | [Temp_opt_max, temp_max]: | | |
| | quadratic | | |
| | Greater than temp_max = 0 | | |

Based on the data features, as expressed above (e.g., continuous, binary, etc.), the agricultural computer system 130 is programmed or configured to determine stripe rust risk associated with the specific crop in the field 105. In particular, the agricultural computer system 130 is configured or programmed to cumulate the risk for the crop, from planting until the current date, whereby the daily risk (or hourly or other interval risk) for the crop based on the above thresholds for the different data features is summed to provide an overall risk of stripe rust for the crop in the field 105.

In this way, in connection with predicting disease risk (e.g., for stripe rust, etc.) on a particular date, if there was a particular fungicide application in the past within a last 10-30 days, etc., the stripe rust model may configure or program the agricultural computer system 130 to determine a relatively low risk for the disease. However, if the particular fungicide application was done in the past more than 30 days ago, the stripe rust model may configure or program the agricultural computer system 130 to interpret the fungicide effect to have run off and determine a relatively higher risk for the disease.

In this manner, the agricultural computer system 130 is configured to programmed, by the stripe rust model, to determine a daily severity risk of stripe rust infection in the crop in the field 105, for each of the synthetic sprays. That said, it should be appreciated that, while the severity of stripe rust is determined through the stripe rust model 708 in this embodiment, the occurrence of stripe rust may also, or alternatively, be determined through a different version(s) of the model and combined, and then used to determine a predicted response as described below.

Fusarium Model. An example fusarium model (e.g., as a time-series window optimizer, etc.) may configure or program the agricultural computer system 130 to determine a risk of fusarium occurring around flowering time for winter wheat, for example, in the field 105. The risk associated with fusarium, generally, relates to quality of the crop (and not necessarily quantity of yield) and is represented, typically, as either present or not present, for example.

In this example embodiment, the agricultural computer system 130 is configured or programmed to execute each of the models to determine the specific risk, for each of the associated diseases. The output of the disease models is combined into a data structure, which indicates the likely of disease and/or severity, at each day in the forecast period, which, again, may include until the end of the growing season, the end of the calendar year, to some time interval relevant to treatment, etc. For example, the data structure may include a table, with each column representative of a day and each row indicate of a specific one of the above diseases. The value in each cell of the table is then representative of the disease risk/severity for the crop in the field 105. It should be appreciated that the disease risk and/or severity may be combined into a single value, or multiple values, in one or more implementation thereof.

In addition to the disease risk for the crop in the field 105, the agricultural computer system 130 is configured or programmed to also determine a residual protection of one or more prior treatments of the field 105. That is, there is potential for the field 105 to be treated multiple times in a given growing season. The treatment may be applied at different times (e.g., in one or more spray windows, etc.). In general, once applied, the treatment provides protection from one or more diseases (e.g., depending on the disease/treatment, etc.) for a protection interval or interval of efficacy. The protection interval may be ten days, two weeks, three weeks, or long or shorter, etc. As such, in response to a request for a treatment recommendation, the agricultural computer system 130 is configured or programmed to determine if the current date, or a future date includes residual coverage by a prior treatment. In this manner, the agricultural computer system 130 is configured or programmed to determine a prior treatment date and a type of the treatment and to apply a static interval of efficacy, which may be specific to the treatment, from that date of treatment. As such, when a treatment is applied, the agricultural computer system 130 is configured or programmed to identify the dates from the date of application through to the end of the interval as protected dates, or day(s) of residual protection.

In addition, the agricultural computer system 130 is configured or programmed to determine a response to the treatment, which is indicated by difference in yield for the field 105 if treated, or not treated.

Specifically, the agricultural computer system 130 is configured or programmed to determine the response of the crop to a treatment (or treatments). The response is determined, in this embodiment, as a delta, or difference, between the crop performance or yield, which is predicted with the treatment, relative to the control prediction for the crop. The control prediction for the crop may include the crop without any treatment, or depending on the growth stage, the crop subject to only prior treatments. For example, with referent to FIG. 2, when a grower opts to treat the field 105 in spray window T1, the control in the spray window T2 will include the crop, as already impacted by the spray in spray window T1. Historical data may be used to determine the response, whereby for an application in spray window T2, the agricultural computer system 130 is configured or programmed to determine a yield for application in the T1 and T2 spray windows, less a benchmark yield, which includes only a treatment in spray window T1, from multiple prior years of data related to various different fields. The historical data may be aggregated over time, for example, to provide a mean/average, or may be maintained as a time series, which provides, potentially, a probabilistic return on investment (ROI) with regard to yield. It should be understood that the historical data may be specific to the crop in the field 105, and also potentially, specific to location (e.g., country, region, region-type, etc.), treatment type/formula, sample size, etc.

The response is expressed as a yield difference (e.g., in bushels per acre, etc.). The agricultural computer system 130 is configured or programmed, as explained above, to access the other data, specifically, the grain price and the cost data for the application. The expression below defines a return on investment, or ROI, and, in this example, the agricultural computer system 130 is configured or programmed to calculate the ROI for the treatment therewith.

$$ROI = \frac{GrainPrice * ( Yeild Response ) - TreatmentCost}{TreatmentCost}$$

The ROI may be determined as a discrete value for each of the days included until the end to the calendar year, or season, or may be expressed as a probabilistic ROI, which is based on the probabilistic response, treatment cost, grain price, etc. The ROI may further be calculated as a probability of breaking even between the enhanced revenue based on the treatment of field 105, as compared to the cost of the treatment.

Based on the above data, i.e., the disease risk, the residual protection and optionally the ROI, the agricultural computer system 130 is configured or programmed to determine whether to recommend the treatment.

In particular, in this example, the agricultural computer system 130 is configured or programmed to employ logic associated with the above. For example, agricultural computer system 130 is configured or programmed to determine whether the field is approaching a spray window (e.g., within two, five, seven, ten days, etc.), where the spray window is based on the phenology model predictions of growth stage trajectories and geographical practices (e.g., in some instances BBCH 37 may be considered as part of the second spray window in a season whereas in other instances BBCH 39 may be considered as part of the second spray window in a season, etc.). If the field is not approaching a spray window, the agricultural computer system 130 is configured or programmed to not recommend a spray. If the field is approaching a spray window, the agricultural computer system 130 is configured or programmed to determine if the disease risk exceeds a defined threshold. If it does not, the agricultural computer system 130 is configured or programmed to not recommend a spray. But if the disease risk does exceed the defined threshold, the agricultural computer system 130 is configured or programmed to determine if the residual protection is sufficient to combat the disease. If the residual protection is sufficient, the agricultural computer system 130 is configured or programmed to not recommend a spray. If the residual protection is not sufficient, the agricultural computer system 130 is configured or programmed to recommend a spray, in some examples. Alternatively, the agricultural computer system 130 may be configured or programmed to determine if the ROI satisfies one or more defined threshold. If it does not, the agricultural computer system 130 is configured or programmed to not recommend a spray. But if it does, the agricultural computer system 130 is configured or programmed to recommend a spray.

In this manner, it should be appreciated that the ROI may be relied on, or not, in recommending a spray for the specific field.

When a treatment is recommended, the agricultural computer system 130 is configured or programmed to identify days recommended for application of the treatment. In particular, the agricultural computer system 130 is configured or programmed to apply one or more rules, which rely on at least weather data, in this example embodiment, to classify days (or other intervals) as either good days to treat or bad days to treat. For example, a rule may define a specific temperature range, and a rule may define a precipitation chance threshold, where the rules may be further based on combined intervals. For example, each hour in a day may be considered, and where the forecasted temperature for the hour is within a temperature range, and the hour before and after has a forecasted humidity below a threshold percentage, that hour is a good treatment hour. The hours are then stacked together to define good treatment days. In this way, the agricultural computer system 130 is configured or programmed to identify recommended days, i.e., good treatment days, to apply the recommended treatment for the crop in the field 105. It should be understood that the recommendation may be based on days, as above, or based on shorter intervals, whereby the good or bad treatment interval may be provided in hours or other intervals less than days, or potentially, more than days (e.g., good treatment weeks, etc.).

That said, it should also be appreciated that any forecasted weather data may be considered by any number of rules, which define, generally, acceptable or desired conditions for application of the treatment.

After the recommended treatment days (or other interval) are identified for the recommended treatment (or treatments), the agricultural computer system 130 is configured or programmed to compile a report or output or notice, which includes the recommended treatment and the identified days. In particular, the recommendation output includes, among other things, an identification of the field, for example, by field ID or other unique identifier to track the field (and other fields); an indication of a recommendation to spray (e.g., YES, RECOMMENDED, TRUE, etc.); a reason for the recommendation (e.g., “‘There are dates with a disease risk>=1 that are not protected by fungicide in the next 7 days”, etc.); an indication of the recommended spray window; a date interval, mapping or other representation of the spray window(s) (e.g. {′T1′: [′04-10′, ‘04-29’], ‘T2’: [′05-19′, ‘05-29’], ‘T3’: [′06-12′, ‘06-15’]}, etc.); the specific fungicide recommend (e.g., the same or different per spray window, etc.); dates to spray; favorable dates to spray based on weather conditions; etc. Alternatively, it should be appreciated that the report or output or notice from the agricultural computer system 130 may indicate that no treatment is being recommended.

The agricultural computer system 130 is configured or programmed to transmit the report to the user 102, at device 104. The report, or more broadly, the output, may include an instruction as to the specific days in which the treatment(s) should be applied to the field 105, or potentially, a range of dates and/or time for the application of the recommended treatment(s). In addition, the output may include an indication of the specific treatment(s) to be applied as well as corresponding instructions for the application (e.g., amounts, concentrations, etc.).

It should be appreciated that the user 102 may be responsible for multiple fields, whereby the report may include options for applying treatment(s) to multiple of the fields, whereby the user 102 is permitted to plan and/or coordinate applying the treatment(s) to the different fields.

The treatment recommendation may then be selected by the user 102, via the field manager computing device 104, whereby the user 102 may then order and/or purchase the treatment product(s), for instance, via the agricultural computer system 130, etc. (e.g., whereby the agricultural computer system 130 receives the order, purchase request, etc., from the user 102, in response to the report and a corresponding agreement to the decision and/or recommendation by the user 102; etc.).

The agricultural computer system 130 may then be programmed or configured to direct the selected treatment(s) to the user 102 (e.g., delivering the treatment to the target field 105, etc.). Further, the treatment may be applied, by the user 103 or other party, for example, with the agricultural apparatus 111 to the field 105. This may include the user 102 receiving the treatment and operating agricultural apparatus 111 to treat the field 105. Alternatively, this may include the agricultural computer system 130 being programmed or configured to generate instructions (e.g., in the form of one or more scripts, etc.) based on the treatment and provide the instructions to the agricultural apparatus 111, for example, whereby the agricultural apparatus 111 is configured, by execution of the instructions, to treat the target field (e.g., upon delivery of the treatment recommendation to the agricultural apparatus 111, etc.). In one or more embodiments, the agricultural apparatus 111 (e.g., via sprayers 108, etc.) in the field 105 may be configured, by the one or more scripts generated by the agricultural computer system 130, in connection with the instructions, to be controlled automatically to apply the treatment to the field 105 (e.g., while the user 103 or grower retains other controls associated with the agricultural apparatus 111).

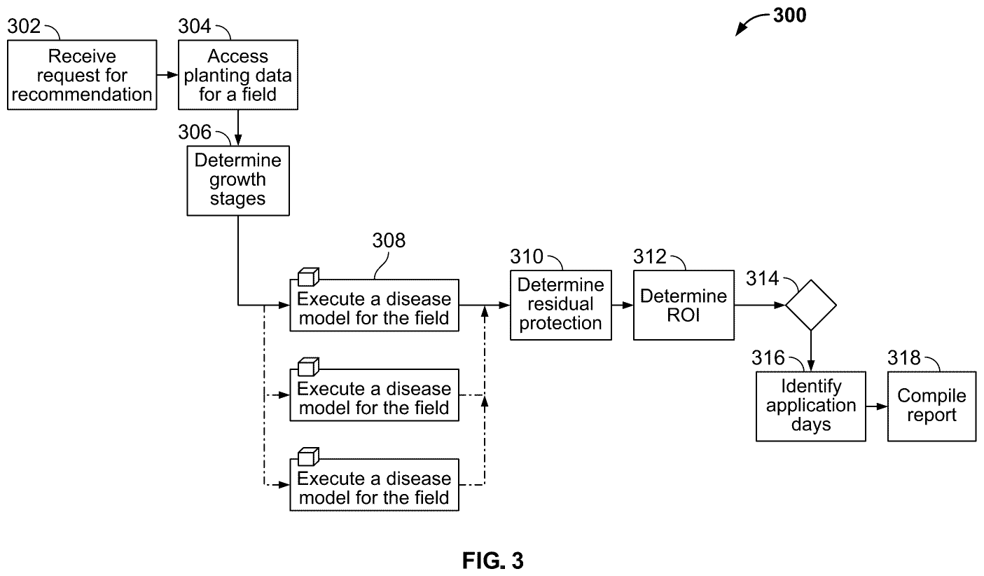

FIG. 3 depicts an example method 300 for use in applying treatments to crops in growing spaces. The method 300 is described in connection with the example system 100, and in particular, the agricultural computer system 130, and the example computing devices described herein. However, it should be appreciated that the method 300 is not limited to the system 100, and may be implemented in a variety of different systems associated with agricultural fields related thereto and/or included therein. Likewise, the systems herein should not be understood to be limited to the example method 300, or other methods described herein.

Initially in method 300, the agricultural computer system 130 receives a request for a recommendation, at 302. The request may be received from the user 102, via the field manager computing device 104, or from a treatment sales representative or entity, or other party/entity associated with the field 105, the crop included in the field 105 or the agricultural computer system 130, etc. The request, in general, includes an identification of the field 105, or other fields (as the request may be related to multiple fields, etc.), a description of the seed/crop planted in the field 105, a planting date for the field 105, and/or a location of the field 105 (e.g., in latitude and longitude, country, etc.). Alternatively, the request may include an identification of the field 105, whereby the remaining data is accessed, as described below. It should be appreciated that the request may also include an identification of a treatment to be applied to the crop and/or field 105 (e.g., type, brand, ingredients, etc.), an indication of one or more diseases of interest, or other data indicative of the user 102 or another party's preferences related to the treatment, etc.

As shown, at 304, in response to the request, the agricultural computer system 130 accesses different data related to the field 105 (as identified in the request), and potentially other fields, included in the field data 106 and/or the external data 110, from memory associated with the agricultural computer system 130.

The accessed data includes field data 106 specific to the field 105, which includes, at least, a planting date of the crop in the field 105. The field data 106 may also include a location of the field 105, country codes for the country in which the field 105 is located, observations of growth stages for the crop presently in the field 105 (and dates of those observations), as well as any observations of any disease, etc. The accessed data also includes weather data, which includes both historical weather data for prior dates, and forecasted weather data for future dates. It should be appreciated that forecasted weather data may be used for a present day, or limited prior days based on the availability of historical weather data. That said, the weather data includes time series data for the field 105, which includes temperature, humidity, soil moisture, precipitation, depth, daylight, etc. It should be understood that the time series data may include values per day or daily values (e.g., which may be averages, means, maximums, minimums, etc.), or the value may be specific to other intervals, such as, for example, hourly, etc. In one or more embodiments, the agricultural computer system 130 accesses the weather data at a hourly time series and then calculates the averages, means, etc., per day (or other interval), or determines maximum, minimum, etc.

The accessed data may further include other data, such as, for example, grain pricing data, treatment costing data, calendar data, etc.

It should be appreciated that the field data may include field data related to other fields, for example, where the field data includes yield data. The yield data may be indicative of yield for numerous fields, which include the same type of crop as in the field 105, treatment applied, or not, in certain treatment windows, etc., over several years, various regions, etc.

After the data is accessed, as shown in FIG. 3, the agricultural computer system 130 determines, at 306, the growth stage(s) of the crop in the field 105. In particular, the agricultural computer system 130 inputs the time series weather data, along with certain discrete data (e.g., planting date, etc.) to the phenology model, which is a GRU model in this example. The agricultural computer system 130, using the phenology model, defines the growth stage of the crop over an interval, which may include the remainder of the growing season, calendar year, etc. The output from the model includes a listing of days in the future, and the specific growth stages of the crop in the field 105 on those dates. It should be appreciated that only certain growth stages may be included in the output, or all available growth stages.

At 308, the agricultural computer system 130 executes one or more disease models, based on the field data, the growth stages, etc. The number and type of disease models may vary depending on the crop included in the field 105, the region in which the field is located, environmental factors, etc. The variable number of disease model is illustrated in FIG. 3 as one disease model execution step, referenced 308, and two other disease model execution steps shown as optional in broken lines. The disease model(s) may include any of the disease models described above or other suitable model(s). Each disease model will output a predicted occurrence and/or severity of the respective disease, from the current date until a ripening/harvest date, or beyond, for the crop in the field 105 (e.g., a time series output, etc.). It should be appreciated that the disease risk is determined for each day.

Next, at 310, the agricultural computer system 130 determines a residual protection, if any, for the field 105. In particular, the agricultural computer system 130 determines if a treatment was previously applied to the field 105, and if so, what the treatment was and when the treatment was applied to the field 105. The agricultural computer system 130 then determines days of residual protection based on the interval of efficacy of the treatment. For example, where the interval of efficacy is fifteen days, and the treatment was applied ten days ago, the agricultural computer system 130 determines there are five days of residual protection for the field 105 again the disease.

As shown in FIG. 3, optionally in the illustrated method 300, the agricultural computer system 130 also determines, at 312, a ROI for the potential treatment of the field 105. As explained above, the ROI is based on the yield response of the treatment, the price of grain (or winter wheat in this example), the cost of the treatment, etc. The ROI is indicative of the economic effect of applying the treatment.

It should be appreciated that after the growth stages of the crop are determined, the disease risk, residual days, and ROI (when utilized) may then be determined in series, as shown in FIG. 3. However, they may be detrained in one or more different orders, or in parallel, in other embodiments.

For instance, in one example implementation, the agricultural computer system 130 may determine whether the field is approaching a spray window (e.g., within two, five, seven, ten days, etc.), where the spray window is based on the phenology model predictions of growth stage trajectories and geographical practices (e.g., in some instances BBCH 37 may be considered as part of the second spray window in a season whereas in other instances BBCH 39 may be considered as part of the second spray window in a season, etc.). The agricultural computer system 130 may then also determine if the disease risk for the field exceeds a defined threshold and, if the disease risk does exceed the defined threshold, the agricultural computer system 130 may determine if the residual protection is sufficient (or not) to combat the disease. Additionally, or alternatively, the agricultural computer system 130 may then determine if the ROI satisfies one or more defined threshold. In this manner, it should be appreciated that the ROI may be relied on, or not, in recommending a spray for the specific field.

At 314, the agricultural computer system 130 relies on the disease risk, the number of days of residual protection, and the ROI (when utilized) to determine whether to recommend treatment for the field 105, or not.

When the agricultural computer system 130 determines to recommend a treatment, the agricultural computer system 130 then identifies, at 316, recommended application days for the treatment. In particular, the agricultural computer system 130 accesses the forecast weather data and determines the suitability of multiple days to treat the field 105 based on at least the forecasted weather data and one or more rules. The one or more rules, for example, may require a certain temperature, or humidity, for one or more intervals, etc. One example rule may require a humidity below a certain threshold percentage, and temperature within a range for each of three consecutive hours, whereby the middle hour is suitable for treating the field 105. The agricultural computer system 130 may determine the suitability of each hour in this manner, and then, define suitable days, or intervals for the treatment of the field 105.

At 318, after determining one or more suitable application days, the agricultural computer system 130 compiles a report (broadly, output) indicative of the recommendation for the treatment at the field 105. The report includes an indication of the recommendation to treatment the field 105 and also the application days, so that the user 102 is able to proceed consistent with the recommendation. The agricultural computer system 130 transmits the report to the user 102, or other requestor. In one or more embodiments, the method 300 includes applying the treatment to the field 105, via the agricultural apparatus 111, consistent with the recommendation (or report), either automatically, as directed by the agricultural computer system 130, the field manager computing device 104 or otherwise, or manually, by the user 102, etc.

That said, it should be appreciate that not all growers will be able to spray at a specific time, therefore the report may include additional information for other days and associated days for applying the treatment. In this way, the example report provides for a flexibility in the implementation of the methods and systems herein.

It should be appreciated that the method 300 may be repeated or redone at any desired interval, for example, when the grower/user 104 opts not to spray on a given day, whereby an updated report or output or notice may be generated at a later date, consistent with the above. In doing so, the models herein may account for additional real time data (e.g., changes in weather forecasts, etc.). Further, the method 300 can be repeated or redone even when a treatment is provided to a field, for example, to identify timing of a future treatment, etc.

It should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

FIGS. 4A and 4B illustrates two views of an example logical organization of sets of instructions in main memory when an example mobile application is loaded for execution. In FIGS. 4A and 4B, each named element represents a region of one or more pages of RAM or other main memory, or one or more blocks of disk storage or other non-volatile storage, and the programmed instructions within those regions. In one embodiment, in FIG. 4A, a mobile computer application 400 comprises account, fields, data ingestion, sharing instructions 402, overview and alert instructions 404, digital map book instructions 406, seeds and planting instructions 408, treatment instructions 410, weather instructions 412, field health instructions 414, and performance instructions 416.

In one embodiment, a mobile computer application 400 comprises account, fields, data ingestion, sharing instructions 402 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 400 comprises a data inbox. In response to receiving a selection of the data inbox, the mobile computer application 400 may display a graphical user interface for manually uploading data files and importing uploaded files to a data manager.

In one embodiment, digital map book instructions 406 comprise field map data layers stored in device memory and are programmed with data visualization tools and geospatial field notes. This provides growers with convenient information close at hand for reference, logging and visual insights into field performance. In one embodiment, overview and alert instructions 404 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 408 are programmed to provide tools for seed selection, hybrid placement, and script creation, including variable rate (VR) script creation, based upon scientific models and empirical data. This enables growers to improve and/or maximize yield or return on investment through optimized seed purchase, placement and population.

In one embodiment, script generation instructions 405 are programmed to provide an interface for generating scripts, including variable rate (VR) fertility scripts. The interface enables growers to create scripts for field implements, such as nutrient applications, planting, and irrigation. For example, a planting script interface may comprise tools for identifying a type of seed for planting. Upon receiving a selection of the seed type, mobile computer application 400 may display one or more fields broken into management zones, such as the field map data layers created as part of digital map book instructions 406. In one embodiment, the management zones comprise soil zones along with a panel identifying each soil zone and a soil name, texture, drainage for each zone, or other field data. Mobile computer application 400 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 400 may make the script available for download in a format readable by an application controller, such as an archived or compressed format. Additionally, and/or alternatively, a script may be sent directly to cab computer 115 from mobile computer application 400 and/or uploaded to one or more data servers and stored for further use.

In one embodiment, treatment instructions 410 are programmed to provide tools to inform treatment decisions by visualizing the availability of treatments to crops. This enables growers to improve and/or maximize yield or return on investment through the parameters of certain treatments (e.g., nitrogen, fertilizer, fungicides, other nutrients (such as phosphorus and potassium), pesticide, and irrigation, etc.) applied during the season. Example programmed functions include displaying images such as SSURGO images to enable drawing of fertilizer application zones and/or images generated from subfield soil data, such as data obtained from sensors, at a high spatial resolution (as fine as millimeters or smaller depending on sensor proximity and resolution); upload of existing grower-defined zones; providing a graph of plant nutrient availability and/or a map to enable tuning application(s) of nitrogen across multiple zones; output of scripts to drive machinery; tools for mass data entry and adjustment; and/or maps for data visualization, among others.

“Mass data entry,” in this context, may mean entering data once and then applying the same data to multiple fields and/or zones that have been defined in the system; example data may include treatment application data that is the same for many fields and/or zones of the same grower, but such mass data entry applies to the entry of any type of field data into the mobile computer application 400. For example, treatment instructions 410 may be programmed to accept definitions of application and practices programs and to accept user input specifying to apply those programs across multiple fields. For example, “nitrogen application programs,” in this context, refers to stored, named sets of data that associates: a name, color code or other identifier, one or more dates of application, types of material or product for each of the dates and amounts, method of application or incorporation such as injected or broadcast, and/or amounts or rates of application for each of the dates, crop or hybrid that is the subject of the application, among others. Such “nitrogen practices programs,” in this context, refer to stored, named sets of data that associates: a practices name; a previous crop; a tillage system; a date of primarily tillage; one or more previous tillage systems that were used; one or more indicators of application type, such as manure, that were used. Treatment instructions 410 also may be programmed to generate and cause displaying a treatment graph, which indicates projections of plant use of the specified treatment and whether a surplus or shortfall is predicted; in some embodiments, different color indicators may signal a magnitude of surplus or magnitude of shortfall. In one embodiment, a treatment graph comprises a graphical display in a computer display device comprising a plurality of rows, each row associated with and identifying a field; data specifying what crop is planted in the field, the field size, the field location, and a graphic representation of the field perimeter; in each row, a timeline by month with graphic indicators specifying each treatment applied and amount at points correlated to month names; and numeric and/or colored indicators of surplus or shortfall, in which color indicates magnitude.

In one embodiment, the treatment graph may include one or more user input features, such as dials or slider bars, to dynamically change the treatment planting and practices programs so that a user may alter the treatment graph. The user may then use his treatment graph and the related treatment planting and practices programs to implement one or more scripts, including variable rate (VR) fertility scripts. Treatment instructions 410 also may be programmed to generate and cause displaying a treatment map, which indicates projections of plant use of the specified treatment and whether a surplus or shortfall is predicted; in some embodiments, different color indicators may signal a magnitude of surplus or magnitude of shortfall. The treatment map may display projections of plant use of the specified treatment and whether a surplus or shortfall is predicted for different times in the past and the future (such as daily, weekly, monthly or yearly) using numeric and/or colored indicators of surplus or shortfall, in which color indicates magnitude. In one embodiment, the treatment map may include one or more user input features, such as dials or slider bars, to dynamically change the treatment planting and practices programs so that a user may alter his treatment map, such as to obtain a preferred amount of surplus to shortfall. The user may then use his optimized treatment map and the related treatment planting and practices programs to implement one or more scripts, including variable rate (VR) fertility scripts.

In one embodiment, weather instructions 412 are programmed to provide field-specific recent weather data and forecasted weather information. This enables growers to save time and have an efficient integrated display with respect to daily operational decisions.

In one embodiment, field health instructions 414 are programmed to provide timely remote sensing images highlighting in-season crop variation and potential concerns. Example programmed functions include cloud checking, to identify possible clouds or cloud shadows; determining indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 416 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 416 may be programmed to communicate via the network(s) 109 to back-end analytics programs executed at agricultural computer system 130 and/or external data server computer 108 and configured to analyze metrics such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of cab computer 115. For example, referring now to FIG. 4B, in one embodiment a cab computer application 240 may comprise maps-cab instructions 422, remote view instructions 424, data collect and transfer instructions 426, machine alerts instructions 428, script transfer instructions 430, and scouting-cab instructions 432. The code base for the instructions of FIG. 4B may be the same as for FIG. 4A and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 422 may be programmed to provide map views of fields, farms or regions that are useful in directing machine operation. The remote view instructions 424 may be programmed to turn on, manage, and provide views of machine activity in real-time or near real-time to other computing devices connected to the system 130 via wireless networks, wired connectors or adapters, and the like. The data collect and transfer instructions 426 may be programmed to turn on, manage, and provide transfer of data collected at sensors and controllers to the system 130 via wireless networks, wired connectors or adapters, and the like. The machine alerts instructions 428 may be programmed to detect issues with operations of the machine or tools that are associated with the cab and generate operator alerts. The script transfer instructions 430 may be configured to transfer in scripts of instructions that are configured to direct machine operations or the collection of data. The scouting-cab instructions 432 may be programmed to display location-based alerts and information received from the system 130 based on the location of the field manager computing device 104, agricultural apparatus 111, or sensors 112 in the field and ingest, manage, and provide transfer of location-based scouting observations to the system 130 based on the location of the agricultural apparatus 111 or sensors 112 in the field.

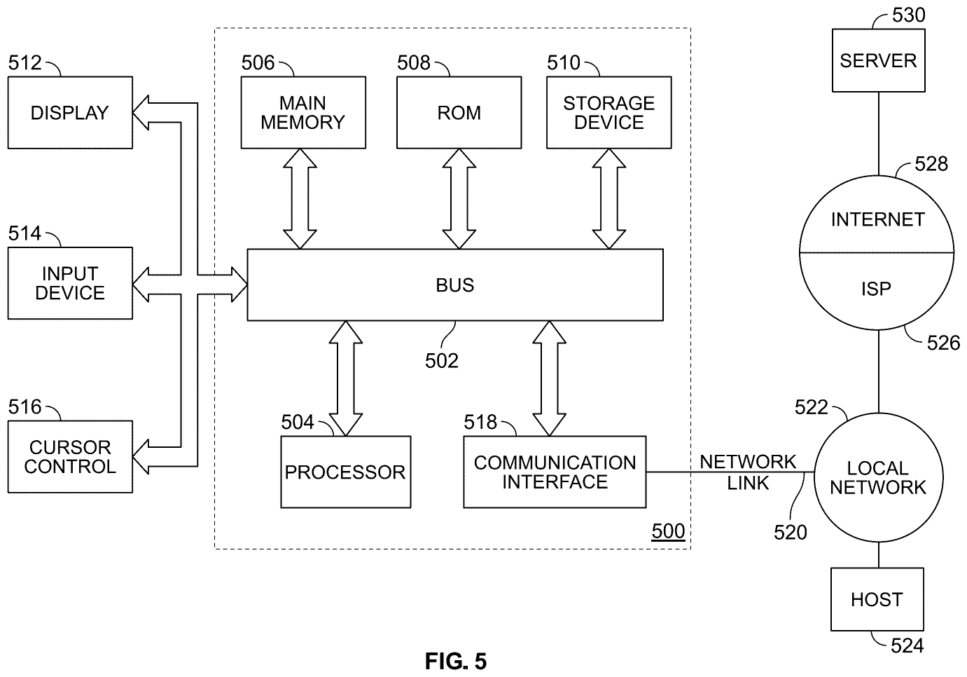

For example, FIG. 5 is a block diagram that illustrates a computer system 500 upon which one or more embodiments of the present disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), liquid crystal display (LCD), light emitting diode (LED), etc., for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device may, for example, have two degrees of freedom in two axes, a first axis (e.g., x, etc.) and a second axis (e.g., y, etc.), that allows the device to specify positions in a plane. The input device 514, more generally, includes any device through which the user is permitted to provide an input, data, etc., to the computer system 500.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infrared data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infrared signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 430 might transmit a requested code for an application program through Internet 528, ISP 526, local network 522 and communication interface 518.

The received code may be executed by processor 504 as it is received, and/or stored in storage device 510, or other non-volatile storage for later execution.

As will be appreciated based on the foregoing specification, the above-described embodiments of the disclosure may be implemented using computer programming or engineering techniques including computer software, firmware, hardware or any combination or subset thereof, wherein the technical effect may be achieved by one or more of: the claimed limitations. For example, the technical effect of the above-described embodiments of the disclosure may be achieved by performing at least one of the operations recited in the claims, including: (a) receiving a request to recommend an application of a treatment for a field, the field including a crop, which is associated with a planting day indicative of the day the crop was planted, the request including a field identifier (ID) for the field; (b) accessing a data structure based on the field ID, the data structure including a planting date of the crop in the field and weather data for the field, the weather data defining time series weather data for an interval; (c) determining a growth stage vector indicative of a growth stage of the crop during each increment of the interval, using a gated recurrent unit (GRU)-based phenology model, based on the planting date and weather data included in the data structure; (d) determining at least one disease risk for the crop in the field, based on at least one disease risk model and the growth stage vector, the at least one disease risk indicative of an occurrence and/or a severity of at least one disease; (c) determining a residual protection of the field for at least one prior treatment of the field; (f) determining whether application of the treatment is recommended for the field based on the at least on disease risk and the determined residual protection; (g) in response to determining that application of the treatment is recommended, identifying multiple application intervals for the treatment based on the weather data for the multiple application intervals; (h) reporting a recommendation to apply the treatment to the field and the application intervals, in response to the request to recommend the application of the treatment; and/or (i) determining a return on investment (ROI) for the treatment.

With that said, example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in applying a treatment to crops in one or more fields, the method comprising:
receiving, at a computing device, a request to recommend an application of a treatment for a field, the field including a crop, which is associated with a planting day indicative of the day the crop was planted, the request including a field identifier (ID) for the field;
accessing a data structure based on the field ID, the data structure including a planting date of the crop in the field and weather data for the field, the weather data defining time series weather data for an interval;
determining, by the computing device, a growth stage vector indicative of a growth stage of the crop during each increment of the interval, using a gated recurrent unit (GRU)-based phenology model, based on the planting date and weather data included in the data structure;
determining, by the computing device, at least one disease risk for the crop in the field, based on at least one disease risk model and the growth stage vector, the at least one disease risk indicative of an occurrence and/or a severity of at least one disease;
determining a residual protection of the field for at least one prior treatment of the field;
determining whether application of the treatment is recommended for the field based on the at least on disease risk and the determined residual protection;
in response to determining that application of the treatment is recommended, identifying multiple application intervals for the treatment based on the weather data for the multiple application intervals; and
reporting a recommendation to apply the treatment to the field and the application intervals, in response to the request to recommend the application of the treatment.

2. The computer-implemented method of claim 1, wherein the time series weather data includes values indicative of multiple of: mean temperature, high temperature, mean humidity, and precipitation.

3. The computer-implemented method of claim 1, wherein accessing the data structure includes accessing planting data specific to the field based on the field ID.

4. The computer-implemented method of claim 1, further comprising determining, by the computing device, a return on investment (ROI) for the treatment; and
wherein determining whether the treatment is recommended for the field is further based on the ROI.

5. The computer-implemented method of claim 1, wherein the at least one disease model includes multiple of: a septoria model, a leaf rust model, a stripe rust model, and a fusarium model.

6. The computer-implemented method of claim 1, wherein the treatment includes a fungicide.

7. The computer-implemented method of claim 1, wherein the GRU-based phenology model further includes a neural network layer and a thresholding layer, the thresholding layer including a cross entropy cost function.

8. The computer-implemented method of claim 7, wherein the neural network layer is a feedforward neural network layer.

9. The computer-implemented method of claim 1, wherein the GRU-based phenology model includes multiple layers of GRUs, which include more than twenty GRUs.

10. A system for use in applying a treatment to crops in one or more fields, the system comprising at least one computing device configured to:
receive a request to recommend an application of a treatment for a field, the field including a crop, which is associated with a planting day indicative of the day the crop was planted, the request including a field identifier (ID) for the field;
access a data structure based on the field ID, the data structure including a planting date of the crop in the field and weather data for the field, the weather data defining time series weather data for an interval;
determine a growth stage vector indicative of a growth stage of the crop during each increment of the interval, using a gated recurrent unit (GRU)-based phenology model, based on the planting date and weather data included in the data structure;
determine at least one disease risk for the crop in the field, based on at least one disease risk model and the growth stage vector, the at least one disease risk indicative of an occurrence and/or a severity of at least one disease;
determine a residual protection of the field for at least one prior treatment of the field;
determine whether application of the treatment is recommended for the field based on the at least on disease risk and the determined residual protection;
in response to determining that application of the treatment is recommended, identify multiple application intervals for the treatment based on the weather data for the multiple application intervals; and
report a recommendation to apply the treatment to the field and the application intervals, in response to the request to recommend the application of the treatment.

11. The system of claim 10, further comprising an agricultural apparatus in communication with the at least one computing device; and
wherein the at least one computing device is further configured to transmit instructions to the agricultural apparatus to apply the treatment to the field consistent with the recommendation.

12. The system of claim 10, wherein the time series weather data includes values indicative of multiple of: mean temperature, high temperature, mean humidity, and precipitation.

13. The system of claim 10, wherein the at least one computing device is configured, in order to access the data structure, to access planting data in the data structure specific to the field based on the field ID.

14. The system of claim 10, wherein the at least one computing device is further configured to determine a return on investment (ROI) for the treatment; and
wherein the at least one computing device is configured, in order to determine whether the treatment is recommended for the field, to determine whether the treatment is recommended for the field further based on the ROI.

15. The system of claim 10, wherein the at least one disease model includes multiple of: a septoria model, a leaf rust model, a stripe rust model, and a fusarium model.

16. The system of claim 10, wherein the treatment includes a fungicide.

17. The system of claim 10, wherein the GRU-based phenology model further includes a neural network layer and a thresholding layer, the thresholding layer including a cross entropy cost function.

18. The system of claim 10, wherein the neural network layer includes a feedforward neural network.

19. The system of claim 10, wherein the GRU-based phenology model includes multiple layers of GRUs, which include more than twenty GRUs.

20. A non-transitory computer readable storage medium including executable instructions for use in identifying treatments for application to crops in one or more fields, which when executed by at least one processor, cause the at least one processor to:
receive a request to recommend an application of a treatment for a field, the field including a crop, which is associated with a planting day indicative of the day the crop was planted, the request including a field identifier (ID) for the field;
access a data structure based on the field ID, the data structure including a planting date of the crop in the field and weather data for the field, the weather data defining time series weather data for an interval;
determine a growth stage vector indicative of a growth stage of the crop during each increment of the interval, using a gated recurrent unit (GRU)-based phenology model, based on the planting date and weather data included in the data structure;
determine at least one disease risk for the crop in the field, based on at least one disease risk model and the growth stage vector, the at least one disease risk indicative of an occurrence and/or a severity of at least one disease;
determine a residual protection of the field for at least one prior treatment of the field;
determine whether application of the treatment is recommended for the field based on the at least on disease risk and the determined residual protection;
in response to a determination that application of the treatment is recommended, identify multiple application intervals for the treatment based on the weather data for the multiple application intervals; and
report a recommendation to apply the treatment to the field and the application intervals, in response to the request to recommend the application of the treatment.
